(19) United States
(12) Patent Application Publication
(10) Pub. No.: US 2005/0233806 A1
(43) Pub. Date: Oct. 20, 2005

(54) Multiple meters for electronic gaming

(76) Inventors: Steven N. Kane, Brookline, MA (US); Mark E. Herrmann, Wellesley, MA (US); Jason Yanowitz, Amherst, MA (US); Stuart Roseman, Boston, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/057,694

(22) Filed: Feb. 14, 2005

Related U.S. Application Data
(60) Provisional application No. 60/544,470, filed on Feb. 13, 2004.

(51) Int. Cl. G06F 17/00

(52) U.S. Cl. 463/31

(57) ABSTRACT

Multiple game meters can be used in any electronic game to visually represent at least play and game status. Such meters may be interconnected and used in subscription games of skill or chance, including those with multiple individuals playing against each other.

### RELATED APPLICATION

This application claims priority under 35 U.S.C. § 119(e) to U.S. Provisional Application Ser. No. 60/544,470, entitled “MULTIPLE METERS FOR ELECTRONIC GAMING,” filed on Feb. 13, 2004, which is herein incorporated by reference in its entirety.

### FIELD OF THE INVENTION

The present invention relates to visual indicators used in games, and more particularly, to meters for displaying a player's progress in a game session.

### DESCRIPTION OF THE RELATED ART

Visual meters have been used since the advent of electronic games to convey information to a player. In an electronic game, a meter has been used to display a player's health, the amount of time left, the amount of ammunition left, and how much a game level has been completed among numerous other items.

As a specific example, EA Pogo's “Squelchies” internet electronic game has two meters. In “Squelchies”, groups of differently colored beings called “squelchies” progress slowly down a screen. A player moves a bottom “squelchie” from a column to another column to make groups of three or more “squelchies” of the same color. As the needed groups are formed, the matched “squelchies” disappear. A round is completed and won when enough matches are made. The game is lost if any one “squelchie” touches the screen bottom. The first meter in the game is a hermit crab that walks across the bottom as more “squelchies” are removed from the screen by the player. This meter moves only in one direction as play progresses. The second meter indicates the number of groups of “squelchies” that must be defeated by the player to complete the round and how many have already been defeated. If a player loses, the game is over and thus this meter also advances in only one direction.

### SUMMARY OF THE INVENTION

There is a present and recurring need for more versatile multiple meters for electronic games. According to one aspect of the present invention, improved meters are provided that present improved indications to a player during game play. According to one aspect, first and second meters are provided wherein an output of the first meter is coupled to an input of the second meter, wherein the first meter is indicative of the quality of play by the player. The first meter may be adjusted upwards or downwards, depending on the quality of play by the player. If the player plays at a lower quality level for a period of time such that the first meter attains a predetermined low level, game play may be terminated, and the player loses the game. If, however, the play by the player is a high quality, this high quality play may be indicated by an increase in the indication shown on the first meter. If the quality of play reaches a particular maximum amount, the game level may be increased as represented by the second meter, and the first meter may then be reset (e.g., to a default value).

Another aspect of the invention relates to an indication of poor play and downward progression of the player as a result of the poor play. In one aspect of the invention, as poor play causes the first meter to reach a minimum level, an indication of the second meter is reduced, as the game level at which the user plays is decreased. At some minimum point in game play and game level, the player may be removed (or eliminated) from the game. This operation contrasts to conventional game meters that generally operate in a single direction (e.g., time remaining decreases, number of bullets decreases), measure a single parameter (e.g., life), and do not otherwise have a connection to other parameters of other meters. According to one aspect of the present invention, poor game play may cause the game level to be reduced, increasing the quality of the gaming experience. This may be beneficial, for example, for a player that achieves a certain level, but based on their game play within that level, cannot achieve a higher level or otherwise fails to succeed within the certain level. If game play within the certain level degrades, the player may be dropped down to a previous level, and the player may continue to play at that lower level until the player's game play increases to a point at which the game level may be increased. Conventionally, a player is eliminated from a game entirely if the player cannot progress the game beyond the next level, or is eliminated if the player fails within a particular level.

In another aspect of the present invention, a third meter is provided that indicates a prize level that correlates to a prize that can be received by the player. In one embodiment, the third meter may be responsive to a second meter that indicates a level of game play. The prize level may be increased or decreased responsive to the level of play. In another embodiment, the third meter may be responsive to a first meter indicating the quality of play of the player within a particular game level. In yet another embodiment, the third game meter may be responsive to both first and second meters as described above.

According to one aspect of the present invention an interface of a game is provided, the interface being stored in a memory of a computer system having a display and being presented by the computer system to a player of the game. The interface comprises a first meter, and a second meter, wherein the first and second meters are displayed to the player in the display of the computer system, wherein the second meter is adaptively coupled to the first meter. According to one embodiment of the present invention, the game is an electronic game. According to another embodiment of the present invention, the game is a game of skill. According to another embodiment of the present invention, the game is a game of chance. According to another embodiment of the present invention, the game player plays the game through the interface. According to another embodiment of the present invention, the player is permitted to subscribe to play one or multiple game sessions though the interface. According to another embodiment of the present invention, the player is permitted to automatically renew the subscription through the interface. According to another embodiment of the present invention, the player is permitted to enter a game session through an alternative method of entry (AMOE).

According to one embodiment of the present invention, the game involves a plurality of players, each of which plays against the others individually or collectively. According to another embodiment of the present invention, a player is presented the interface through at least one of a television, a personal computer, a handheld device, a telephone having a display, and a kiosk. According to another embodiment of the present invention, the first meter indicates a play level and the second meter indicates a game level. According to another embodiment of the present invention, at least one of the first and second meters are initialized to an initial value. According to another embodiment of the present invention, the initial value is greater than a minimum value permitted by the at least one of the first and second game meters. According to another embodiment of the present invention, the initial value is a middle value proximate the center of an allowed range of indications shown by the at least one of the first and second game meters.

According to one embodiment of the present invention, good play by the player increases a displayed value of the first meter and poor play by the player decreases the displayed value of the first meter. According to another embodiment of the present invention, a displayed value of the second meter increases when the first meter attains a maximum level and the displayed value of the second meter decreases when the first meter attains a minimum level. According to another embodiment of the present invention, the displayed value of the first meter is reset to an initial value when at least one of a minimum level and a maximum level indicated by the first meter is reached. According to another embodiment of the present invention, game play for the player is ended when the displayed value of the second meter reaches a minimum level. According to another embodiment of the present invention, the difficulty of the game adjusts as levels displayed by the first and second meters change. According to another embodiment of the present invention, the interface further comprises a third meter that indicates a prize level.

According to one embodiment of the present invention, the third meter is initialized to a level that corresponds to the player not winning a prize. According to another embodiment of the present invention, a displayed value of the third meter is increased when a displayed value of the second meter reaches a maximum level and is decreased when the displayed value of the second meter reaches a minimum level. According to another embodiment of the present invention, the game is a timed game, and wherein the player plays the game within a time limit. According to another embodiment of the present invention, the game is a timed game, and wherein each of the plurality of players plays the game within a time limit. According to another embodiment of the present invention, the interface of the game further comprises a third meter that indicates a prize level, and wherein the game play of the plurality of players is ended when at least one of the plurality of players attains a maximum prize level indicated by the third meter. According to another embodiment of the present invention, each of the plurality of players plays the game using an interface having a respective third meter that indicates a prize level associated with each respective player, and wherein each of the plurality of players wins prizes indicated by their respective third meter when the time limit is reached.

According to one embodiment of the present invention, no players win if the time limit is reached before the maximum prize level is attained by any one of the plurality of players. According to another embodiment of the present invention, the payout to a player for winning is increased with an increased payment received by the player to play. According to another embodiment of the present invention, the game includes at least one progressive jackpot. According to another embodiment of the present invention, the game includes a plurality of game sessions that are run periodically. According to another embodiment of the present invention, the interface of the game further comprises means for displaying, to a plurality of players playing the game, an indication of a winning player.

According to one embodiment of the present invention, the interface of the game further comprises means for displaying, to a plurality of players playing the game, an indication of at least one of a winning game and a winning player. According to another embodiment of the present invention, the computer system determines at least one of a game card or a player closest to winning, and the interface further comprises means for displaying to at least one of a plurality of players playing the game an indication of the at least one of the game card or the player closest to winning. According to another embodiment of the present invention, game sessions are run continuously, and wherein at least one advertising stream is inserted into the interface during a game session. According to yet another embodiment of the present invention, game sessions are run continuously, and wherein at least one advertising stream is displayed in the interface between individual game sessions.

The function and advantage of these and other embodiments of the present invention will be more fully understood from the examples described below. The following examples are intended to illustrate the benefits of the present invention, but do not exemplify the full scope of the invention.

### BRIEF DESCRIPTION OF THE DRAWINGS

In the drawings,

FIG. 1 shows a playfield and associated meters according to one embodiment of the present invention;

FIG. 2 shows components of a game computer system according to one embodiment of the present invention;

FIG. 3 shows components of a game payment subsystem according to one embodiment of the present invention;

FIG. 4 shows components of a game payout subsystem according to one embodiment of the present invention;

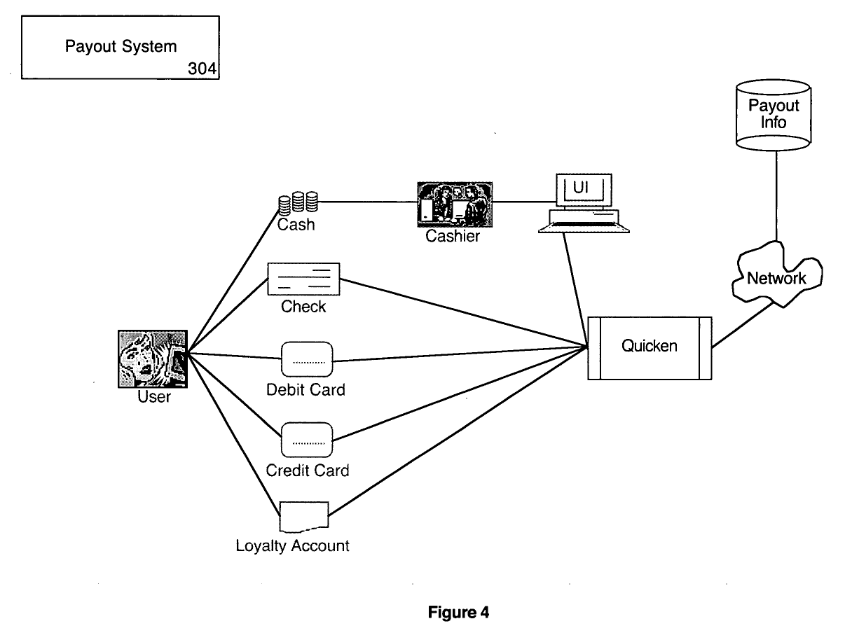

FIG. 5 shows components of a game playing and viewing subsystem according to one embodiment of the present invention;

FIG. 6 shows a general-purpose computer system upon which various aspects of the present invention may be implemented;

FIG. 7 shows a computer data storage system with which various aspects of the present invention may be implemented; and

FIG. 8 is a flow chart of a process for controlling meters according to one embodiment of the present invention.

### DETAILED DESCRIPTION

One aspect of the invention relates to a game having multiple interconnected meters that are visually represented to a player. The game may be, for example, a game played through the use of a computer. Further, the game may be, for example, a game of skill or a game of chance with fixed or non-fixed odds. The game having multiple interconnected meters may be an adaptation of any known game or game hereinafter developed. Some examples of games with which various aspects of the present invention may be implemented include poker, blackjack, dominoes, the Yahtzee game (Yahtzee is a registered trademark of Hasbro Inc., Pawtucket, R.I), dominoes, and the Monopoly game (Monopoly is a registered trademark of Hasbro Inc., Pawtucket, R.I). It should be appreciated that various aspects of the present invention may be implemented with other games, and the invention is not limited to any particular game.

In one embodiment of the present invention, the first meter is a play meter and the second meter is a game meter. Either or both meters may be set to the middle (or any other appropriate starting point) initially, and the values indicated by the first and second meters may be increased or decreased based upon the player's moves during a game. If the value indicated by the play meter attains a maximum level possible, the level indicated by the game meter may then be increased and the value indicated by the play meter may be reset (e.g., to the midpoint level of the play meter). When the value of the game meter attains the maximum level, then the player may win the game. Alternatively, if the value of the play meter attains the minimum level possible, the game meter may then be decreased and the play meter reset to the midpoint. When a game meter attains the minimum level, the game may be ended for the player.

In one embodiment, a third meter may be a prize meter. This third meter may be responsive to information displayed in either or both of the first and second meters. In one example, the value displayed by the third meter may be initially set at the lowest level, the value of which corresponds to the player not winning a prize. Each time the game meter reaches the maximum level possible, an indication as shown by the prize meter may be increased. Similarly, each time the game meter reaches the minimum level, the indication shown by the prize meter may be decreased. In another embodiment, the prize meter may possibly be decreased to a lower limit, where the lower limit indicates that the player does not win a prize.

Prior to a game session, a game player may need to pay for playing. For example, a game player may pay using money or loyalty points. In particular, a game player may pay using money by debit card, credit card, check, cash or from an account credit either with the gaming operator or an affiliated organization. Alternatively, a game player may pay using loyalty points from an account held either by the gaming operator or by an affiliated organization. Loyalty points may be obtained from any type of organization but are generally associated with loyalty programs such as frequent flier programs for airlines, frequent stay programs for hotels or frequent visitor programs for casinos. The game player may pay in person (e.g., by using a cashier) or through other remote methods including a telephone, a handheld device, a kiosk, a computer coupled through the Internet or other network and mail. Payment may be in any form that is legal in the particular jurisdiction.

In one embodiment of the invention, players may subscribe to play multiple consecutive game sessions. That is, one or more players pay to play many consecutive game sessions. According to one embodiment, such players may subscribe to multiple games (e.g., fixed-odds or non-fixed odds games) using a computer-based interface (e.g., a personal computer, a cell phone, PDA, set top box, or other interface). These subscribed games may be automatically played (e.g., by a computer system). In another embodiment, a player may also choose to have his or her subscription automatically renewed.

According to one embodiment of the invention, players may also enter to play this or any other wagering game of chance using an alternative method of entry (AMOE). AMOE is a required available method of entry that does not require a purchase to enter a sweepstake; sweepstakes are usually used as a promotional or marketing tool. An individual entering a sweepstakes by AMOE is required by law to have the same odds of winning each of the available prizes.

A common AMOE method includes requiring an individual interested in entering the sweepstakes send in a postcard with his or her name, address or other contact information. Another AMOE method includes requiring an individual to sign on to a free internet website and to submit the required information for free. Numerous other methods may be used for AMOE. Most sweepstakes limit the number of times one individual or family may enter a sweepstakes by AMOE.

According to one embodiment of the invention, it is realized that an AMOE (alternative method of entry) may be used to enter a game of skill or chance. More particularly, it is possible to develop, implement and run wagering games of skill or chance, including the inventive games described herein, with an AMOE method of entry. AMOE methods are conventionally used to enter a player in a sweepstakes, which is not considered wagering or gambling. Thus, according to one embodiment of the invention, an individual may enter a wagering game of skill or chance by AMOE using, for example, the postcard or the online method outlined above. The wagering game of skill or chance player entering by AMOE may also have the same odds to win the payout associated with the game in which they are entered. The wagering game of skill or chance player entering by AMOE may also be limited to a small number of game sessions within a given period of time; for example a player entering by AMOE may be limited to entering one game session in one year or two game sessions in one month. Other numbers of games and given periods may be any number, and the invention is not limited to any particular implementation.

According to one embodiment, the game session that the game player entering by AMOE is entered into may be determined by the game player on the AMOE entry form. For example, the postcard AMOE may be required to state the date and the time of the game that the game session player wants to enter. Alternatively, the game session entered may be the next starting game session after the AMOE is received and logged. As another alternative, AMOE entries may be assigned to a specific game(s) each hour, day, week, or other time interval.

According to one embodiment, a game has predetermined prize levels associated with the game. Prize levels may be increased as a player progresses further in the game. Prize levels may also include adjustments for a player's subscription. For instance, the prize levels may increase if the player has a multiple game subscription and/or a high payment per game. The prize levels may also be adjusted for numerous other criterion including frequent player credits. Of course, all prize level adjustments must meet any legal requirements for the gaming jurisdiction in which the game is played.

The prize levels for each game may also be supplemented by a jackpot that transfers from game session to game session. These types of jackpots are commonly referred to rolling or progressive jackpots. A rolling jackpot may be, for example, the same amount that transfers from game session to game session until the jackpot is paid out. A progressive jackpot is a rolling jackpot that increases as more game sessions, game cards, or other criterion are played.

The final prize level may also be affected by bonus play, which is well-known in the gaming industry. Bonus play works to increase some payouts by offering the player a chance to multiply a payout.

One or more game sessions may proceed concurrently. Parameters of concurrent game sessions may be the same, similar, or different. Additionally, game sessions may run continually, i.e. one after another. When one game session ends, another game session may begin immediately or in a short period of time. Game sessions may follow a precise time schedule so that players know when games will begin. For example, if game play in a game session requires four and a half (4.5) minutes to complete, then the next game session may start immediately or in a defined period (e.g., thirty seconds) to maintain to a schedule of game sessions. For instance, game sessions may begin every five minutes (e.g., at :00, :05, :10, :15, :20, :25, :30, :35, :40, :45, :50, :55 of each hour). Because, according to one embodiment, game sessions may run continually, it may be possible that a particular game session may have no game player playing within the particular game session.

In one embodiment, the computer system may display the game(s) or the identity of the game player(s) closest to winning to all game players during the game session. The computer system may also choose to display only one or a subset of all the game sessions or identities of players closest to winning to a particular game player playing or observing the game session.

In one embodiment, the computer system may then notify all game players playing the game session that a win has occurred. Additionally, the computer system may display the winning game, the winning player's identity, the payout, or prize.

During a period of time between game sessions, a game operator may make announcements, rest, or any number of actions. If the game is played using a computer system, advertisements, sponsorships, public service announcements or any visual or auditory content may be inserted into these periods. Advertisements and any other content may also be inserted into the game display during a game session.

In one embodiment of the present invention, game sessions and game play are partially or fully automated and monitored using one or more computer systems. A computer system may be a single computer that may be a supercomputer, minicomputer, mainframe computer, or personal computer. A computer system used to run a game and its associated game sessions may include a combination of one or more computer systems (of one or more computer system types) that cooperate to accomplish system-level tasks. The computer system also may include input or output devices, displays, or storage units. It should be appreciated that any computer system or systems may be used, and the invention is not limited to any number, type, or configuration of computer systems.

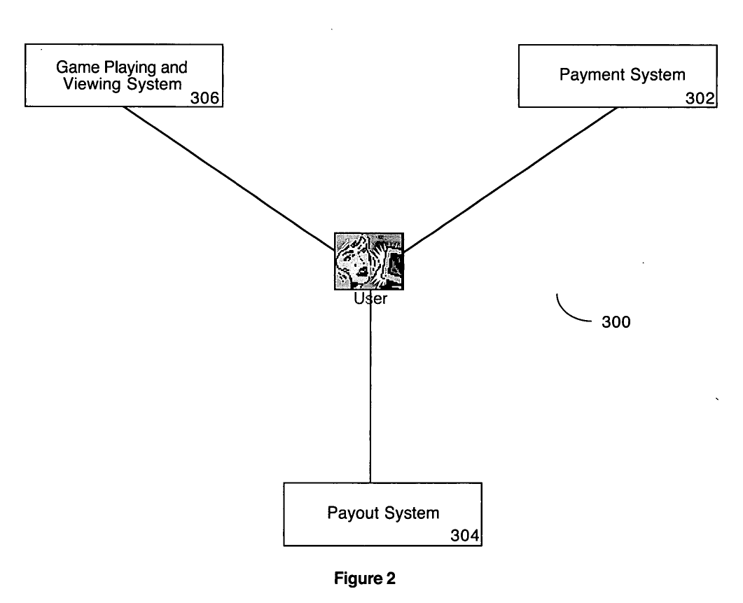

A computer system to run the game described above may include one or more component systems (e.g., system 300 as shown in FIG. 2). One system may handle payment, subscription, and/or AMOE by players to enter the game. Another system may handle playing and viewing the game and the third system may handle payouts. The game system may also be connected by direct line or network to other computer systems including systems for handling casino or hotel loyalty programs, reservations, in-room television viewing, or gambling floor kiosks. Connections to other computer systems may be performed using one or more of the system components described below.

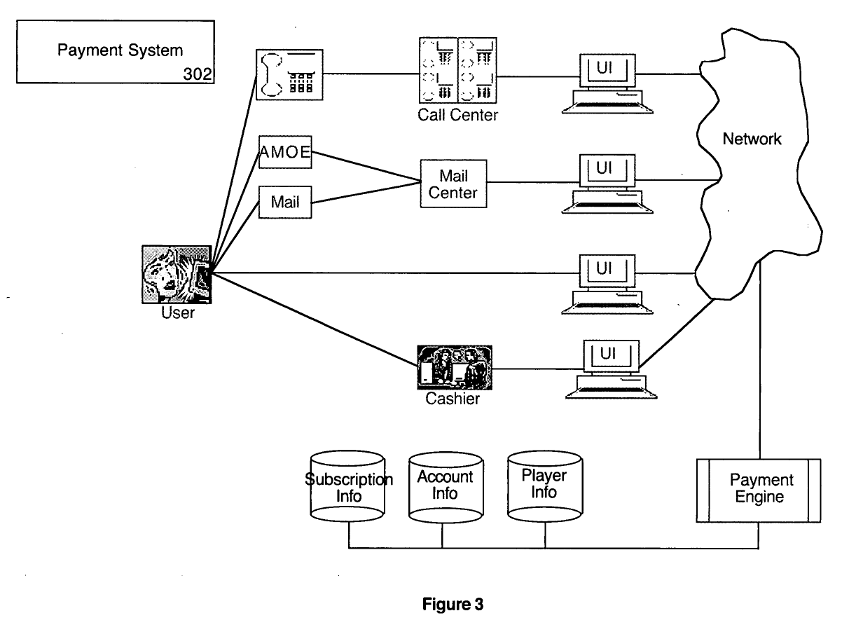

A payment component (e.g., system 302) may include one or more of a number of well-known systems (e.g., as shown in FIG. 3). For example, a player may be able to pay to play one or more games using a telephone and speaking with a call center representative who manually inputs player, payment, and subscription information into a computer using a user interface. In the computer, data may be stored in a data structure that is stored in a memory of the computer system. As used herein, a “data structure” is an arrangement of data defined by computer-readable signals. These signals may be read by a computer system, stored on a medium associated with a computer system (e.g., in a memory, on a disk, etc.) and may be transmitted to one or more other computer systems over a communications medium such as, for example, a network. Also as used herein, a “user interface” or “UI” is an interface between a human user and a computer that enables communication between a user and a computer. Types of UIs include a graphical user interface (GUI), a display screen, a mouse, a keyboard, a keypad, a track ball, a microphone (e.g., to be used in conjunction with a voice recognition system), a speaker, a touch screen, a game controller (e.g., a joystick) etc, and any combinations thereof.

Player information may also be entered into a payment system component. Player information that may be input includes name, address, telephone number, and age. Payment information associated with the player may include a credit or debit card number or loyalty account information. Subscription information for games to which the player subscribes may include first game date and time, number of games to play, and bet per game. Based upon the payment and subscription information, the call center representative may then verify that the payment information is valid and that enough credit or funds is available for the player's desired subscription.

A similar system may exist for players entering using the mail or a post card AMOE except the call center may be replaced by a mail center having representatives that enter information into one or more computers via a user interface. For example, a cashier that works at a casino directly with players that pay cash or credit to play, may also have the ability to input player, account, and subscription information using a user interface of a computer system.

Computer systems or pay engines for handling electronic or online payment and subscriptions may also be used. Such systems are well-known, and include such systems as PayPal, iKobo, Verisign, and other systems. Using such a system, a player interacts directly with a user interface to input information into a payment data structure that may be transferred to one or more payment systems (e.g., PayPal).

Various pay systems and one or more user interfaces may be located on one or more computer systems coupled by a network with the computer system(s) containing the player, account, and subscription database(s). As used herein, a “network” or a “communications network” is a group of two or more devices interconnected by one or more segments of transmission media on which communications may be exchanged between the devices.

The above are merely an illustrative embodiment of a pay system component. It should be appreciated that such an illustrative embodiment is not intended to limit the scope of the invention, as any of numerous other implementations of a pay system component, for example, variations of online payment, are possible and are intended to fall within the scope of the invention. For example, the payment system component may include using pay-per-view systems associated with interactive television or the pay engine may additionally deliver a receipt to the player by either e-mail or mail. None of the claims set forth below are intended to be limited to any particular implementation of the pay system unless such claim includes a limitation explicitly reciting a particular implementation.

Payout systems are also well-known. Any of a number of standard systems or payout engines for making payouts for winning may be used. For example, a standard application programming interface such as ‘Quicken’ (available commercially from Intuit Inc., Mountain View, Calif., USA) may be used to write and mail checks or credit a debit card, credit card (if legal in the jurisdiction of play) or loyalty account. ‘Quicken’ may obtain the payout information by accessing a payout data structure across a network. As used herein, an “application programming interface” or “API” is a set of one or more computer-readable instructions that provide access to one or more other sets of computer-readable instructions that define functions, so that such functions can be configured to be executed on a computer in conjunction with an application program.

‘Quicken’ is merely an illustrative embodiment of the payout system. Such an illustrative embodiment is not intended to limit the scope of the invention, as any of numerous other implementations of the payout system, for example, variations of online payout, are possible and are intended to fall within the scope of the invention. Additionally, a cashier may also have access to payout information using a user interface to the payout data structure through a network; the cashier then makes a payment to the winning player based upon the accessed information. None of the claims set forth below are intended to be limited to any particular implementation of a pay system unless such claim includes a limitation explicitly reciting a particular implementation.

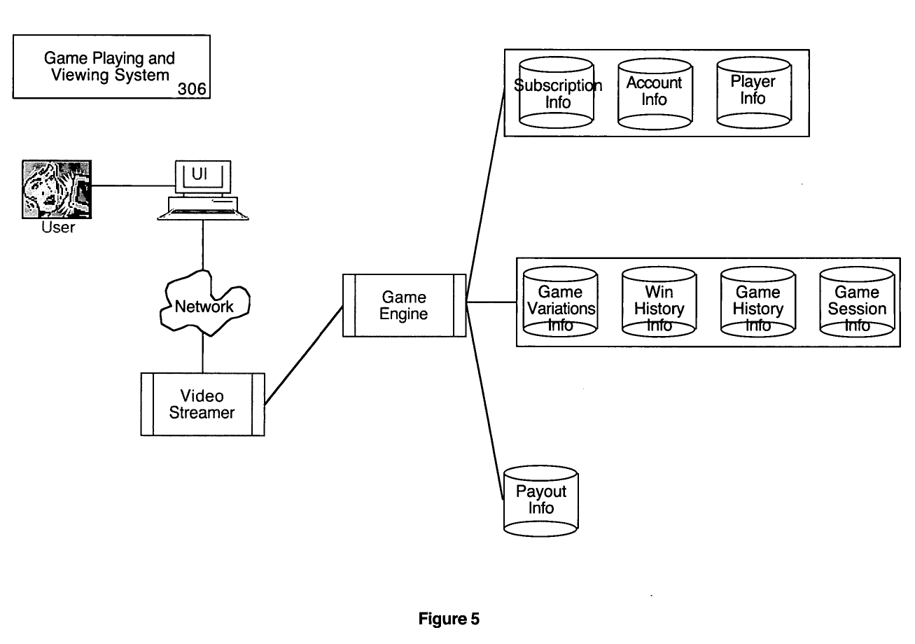

A game playing and viewing system (e.g., system 306) according to one embodiment of the present invention may comprise of a number of components for performing specific functions as shown in FIG. 5. These components may include, for example, storage components that store data structures having information relating to storing game variations, present game session information, game session history, and win history. A game playing and viewing system may also include components used to access payment and payout data structures.

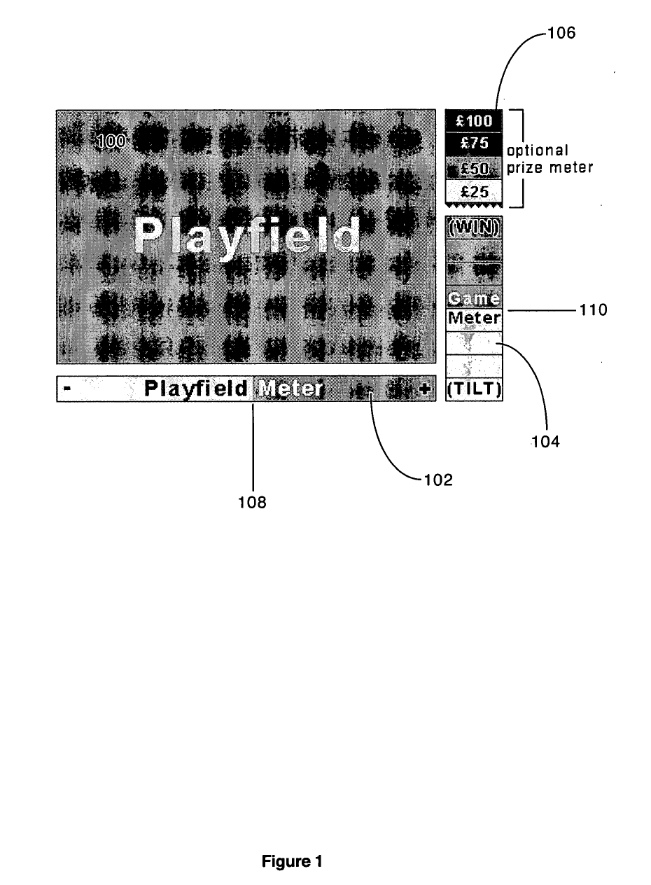

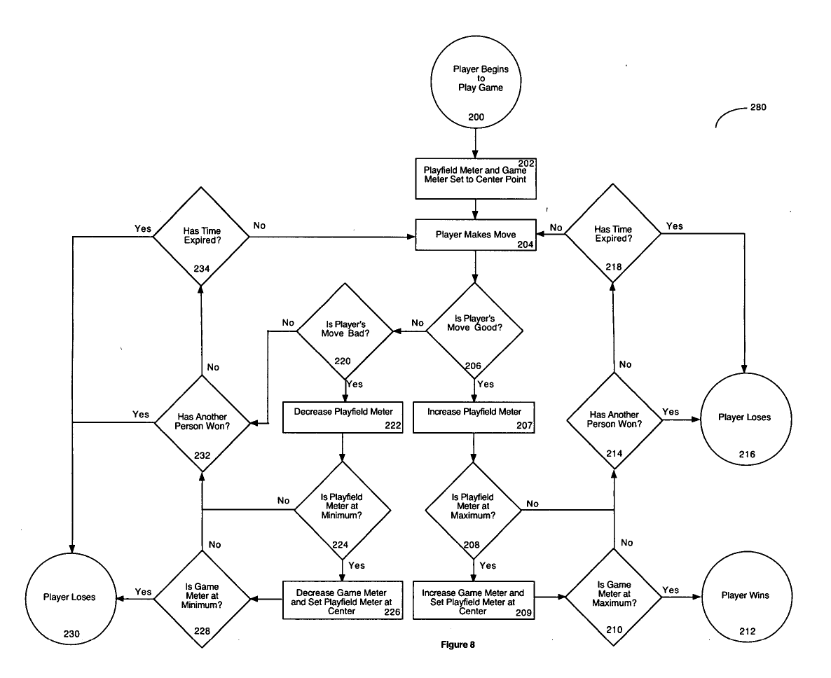

A game playing and viewing system according to one embodiment of the present invention may also include a game engine. A game engine may perform one or more functions relating to conducting a game session. In one example, a game engine may perform functions according to a process 280 as shown in FIG. 8. As shown in FIG. 8, a player may play a game session in an associated interface of a computer system, the computer system presenting, in the associated interface, one or more meters to the player such as those shown in the example interface of FIG. 1.

FIG. 1 shows an example interface of a game according to one embodiment of the present invention. The interface includes a playfield 100 that presents the game to the player. Playfield 100 has associated with it a playfield meter 102 (also referred to herein as a play meter) that measures the play of the player while playing a particular game session. Meter 102 may include a center point 108 that indicates that the play of the player is neither bad nor good. That is, game play in the current game session is neutral. Center point 108 may serve as a starting point for play by the player at the beginning of a particular game session. Meter 102 may also have associated minimum and maximum levels that indicate maximum and minimum play levels by the player.

The game interface may also include an additional play game meter 104 that indicates progress of the player as he/she progresses through the game session. Meter 104 may also include a center point 110 that indicates that the play of the player is neither good nor bad, but is neutral. Meters 102 and 104 may include any visual indications to the player of the player's progress. For example, meters 102 and 104 may include colors, numbers, dials, or any other indication of a player's relative progress and/or quality of play in the game session.

The game interface may also include a prize meter 106 that indicates a prize level. Meter 106 may, for instance, indicate a prize level associated with a player, and when a particular player attains a maximum prize level indicated by his/her prize meter, game play of multiple players playing in a particular game session is ended. Meter 106 may have one or more indications such as color, numbers, prizes, or other indication of a prize won by a player. In one specific example, the prize may be a cash prize in any denomination or currency type (e.g., euros, dollars, pounds, etc.). In another example, there may be a fixed period of time in which a player may win a prize. If that player does not advance the game meter 106 to indicate a prize within the allotted time, the player does not win a prize.

At block 200, the player begins to play the game. At block 202, the computer sets a play meter (e.g., playfield meter 108) and a game meter (e.g., game meter 110) to a center point of the respective meters. The player makes a move at block 204, and at block 206, the computer determines whether the move is good, bad, or neutral. If the move is good, an indicator shown by the play meter is increased (e.g., at block 207).

It may then be determined whether the play meter is at the maximum level (e.g., at block 208). If the play meter is not at a maximum, then the computer may determine if another person has won (at block 214) or if time has expired (at block 218). If either case exists, then the player loses the game at block 216. Otherwise, the player may be permitted to make another move at block 204.

If the play meter is at a maximum level, then the game meter is increased and the play meter is reset to a default level (e.g., the midpoint) at block 209. If the game meter is currently at a maximum level (at block 210), then the player is indicated as winning the game at block 212. Otherwise, the logic proceeds to block 214.

If the player's move is not good (block 206), then it is further determined if the player's move is bad at block 220. A similar logic chain may be then followed for blocks 222 through 234 for when the player's move is bad as for blocks 207 through 218 which are executed when the player's move is good.

If the player is determined to be a winner at block 212, then the computer may proceed to notify the player that he or she is a winner as well as possibly determining a payout amount and notifying the player of the payout amount (e.g., in a game play interface, by e-mail, etc.). The computer may also display the winning game and/or player information to all the game players. Winning player information that may be displayed may include name, city, state, country, and any other identifying information. If multiple winners occur simultaneously, all winners or winning games may be displayed at one time or sequentially. It may also be possible that winners or winning games may be selectively displayed to game players. For instance, if numerous winners occur at one time, a player in Bismarck, North Dakota may be shown only the winning player information or game session that occurred closest to him or her, say in Pierre, South Dakota versus some other location (e.g., Boston, Mass.).

After a game played by the player is found not to be a winner, the computer may also determine whether the player is the closest to winning if there have been no winners. Any of a number of criteria may be used for determining the player closest to winning. For example, the player with the highest game meter and play meter combination may indicate the player closest to winning.

Game play process 280 may include additional acts. Further, the order of the acts performed as part of process 280 is not limited to the order illustrated in FIG. 8, as the acts may be performed in other orders, and one or more of the acts of process 280 may be performed in series or in parallel to one or more other acts, or parts thereof. For example, acts 206 and 220, or parts thereof, may be performed in parallel, and act 214 may be performed at any point during performance of process 280.

Process 280 is merely an illustrative embodiment of the method of game play for a game engine. Such an illustrative embodiment is not intended to limit the scope of the invention, as any of numerous other implementations of the method of game play for a game engine may be used. For example, variations of process 280 are possible and are intended to fall within the scope of the invention. None of the claims set forth below are intended to be limited to any particular implementation of the method of game play for a game engine, unless such claim includes a limitation explicitly reciting a particular implementation.

Process 280, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

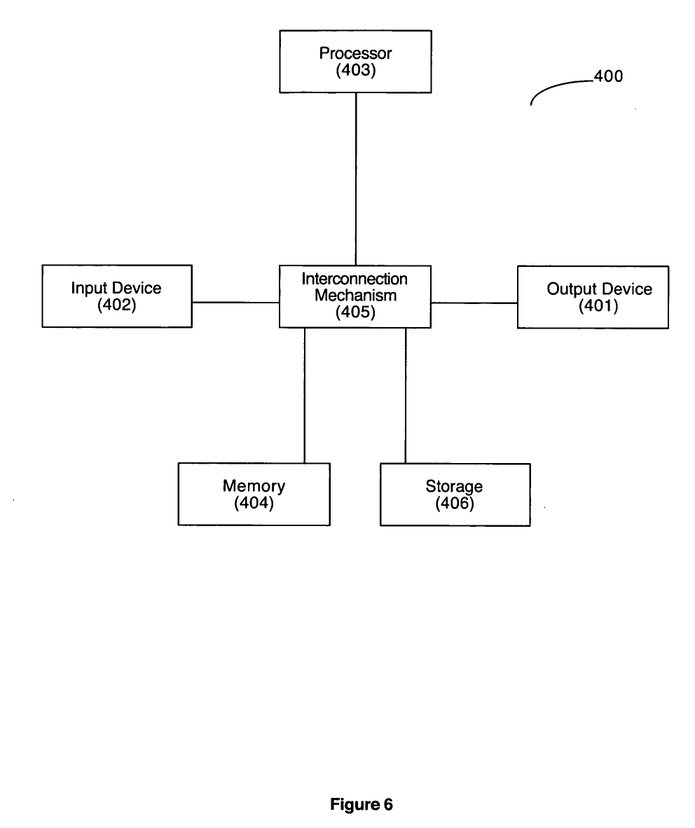

It should be appreciated that any single component or collection of multiple components of a computer system, for example, the computer system described below in relation to FIG. 6, that perform the functions described above with respect to describe or reference the method can be generically considered as one or more controllers that control the above-discussed functions. The one or more controllers can be implemented in numerous ways, such as with dedicated hardware, or using a processor that is programmed using microcode or software to perform the functions recited above.

Another component of the game playing and viewing system may include a software component (e.g., a driver) that streams video via a broadband, satellite or wireless medium to a user interface. If the game is played completely automatically, the user interface may be merely a video terminal including television with no user input means. Viewing access may be controlled by standard means for conditional access including using set top box addresses, telephone numbers or internet protocol (IP) addresses.

The above is merely an illustrative embodiment of a game playing and viewing system. Such an illustrative embodiment is not intended to limit the scope of the invention, as any of numerous other implementations of a game playing and viewing system, for example, variations of conditional access, are possible and are intended to fall within the scope of the invention. None of the claims set forth below are intended to be limited to any particular implementation of a game playing and viewing system unless such claim includes a limitation explicitly reciting a particular implementation.

System 300, and components thereof such as the payment, payout and game engines, may be implemented using software (e.g., C, C#, C++, Java, or a combination thereof), hardware (e.g., one or more application-specific integrated circuits, processors or other hardware), firmware (e.g., electrically-programmed memory) or any combination thereof. One or more of the components of 300 may reside on a single system (e.g., the payment subsystem), or one or more components may reside on separate, discrete systems. Further, each component may be distributed across multiple systems, and one or more of the systems may be interconnected.

Further, on each of the one or more systems that include one or more components of 300, each of the components may reside in one or more locations on the system. For example, different portions of the components of 300 may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

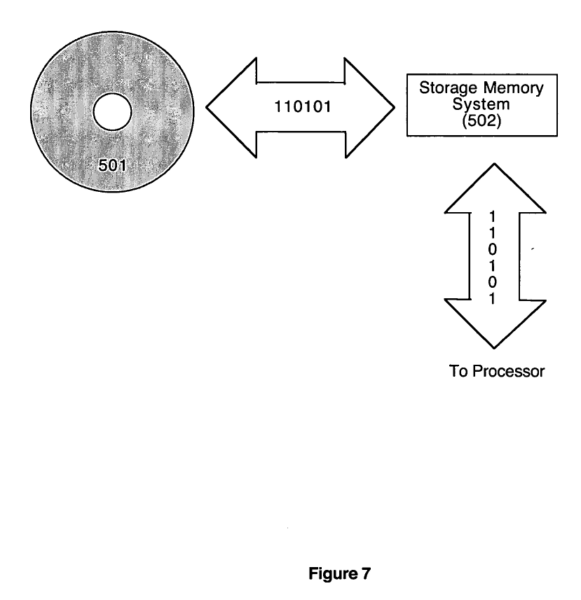

System 300 may be implemented on a computer system described below in relation to FIGS. 6 and 7.

System 300 is merely an illustrative embodiment of the game system. Such an illustrative embodiment is not intended to limit the scope of the invention, as any of numerous other implementations of the game system, for example, variations of 300, are possible and are intended to fall within the scope of the invention. For example, a parallel system for viewing by interactive television may include one or more additional video streamers specific for interactive television. None of the claims set forth below are intended to be limited to any particular implementation of the game system unless such claim includes a limitation explicitly reciting a particular implementation.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate play of the described game according to various embodiments of the invention. Further, the software design system may be located on a single computer or may be distributed among a plurality of computers attached by a communications network.

A general-purpose computer system according to one embodiment of the invention is configured to perform any of the described game functions including but not limited to player subscription or payment, game play, determining winners, and paying winners. It should be appreciated that the system may perform other functions, including network communication, and the invention is not limited to having any particular function or set of functions.

For example, various aspects of the invention may be implemented as specialized software executing in a general-purpose computer system 400 such as that shown in FIG. 6. The computer system 400 may include a processor 403 connected to one or more memory devices 404, such as a disk drive, memory, or other device for storing data. Memory 404 is typically used for storing programs and data during operation of the computer system 400. Components of computer system 400 may be coupled by an interconnection mechanism 405, which may include one or more busses (e.g., between components that are integrated within a same machine) and/or a network (e.g., between components that reside on separate discrete machines). The interconnection mechanism 405 enables communications (e.g., data, instructions) to be exchanged between system components of system 400. Computer system 400 also includes one or more input devices 402, for example, a keyboard, mouse, trackball, microphone, touch screen, and one or more output devices 401, for example, a printing device, display screen, or speaker. In addition, computer system 400 may contain one or more interfaces (not shown) that connect computer system 400 to a communication network (in addition or as an alternative to the interconnection mechanism 405.

The storage system 406, shown in greater detail in FIG. 7, typically includes a computer readable and writeable nonvolatile recording medium 501 in which signals are stored that define a program to be executed by the processor or information stored on or in the medium 501 to be processed by the program. The medium may, for example, be a disk or flash memory. Typically, in operation, the processor causes data to be read from the nonvolatile recording medium 501 into another memory 502 that allows for faster access to the information by the processor than does the medium 501. This memory 502 is typically a volatile, random access memory such as a dynamic random access memory (DRAM) or static memory (SRAM). It may be located in storage system 406, as shown, or in memory system 404, not shown. The processor 403 generally manipulates the data within the integrated circuit memory 404, 502 and then copies the data to the medium 501 after processing is completed. A variety of mechanisms are known for managing data movement between the medium 501 and the integrated circuit memory element 404, 502, and the invention is not limited thereto. The invention is not limited to a particular memory system 404 or storage system 406.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 400 is shown by way of example as one type of computer system upon which various aspects of the invention may be practiced, it should be appreciated that aspects of the invention are not limited to being implemented on the computer system as shown in FIG. 6. Various aspects of the invention may be practiced on one or more computers having a different architecture or components that that shown in FIG. 6.

Computer system 400 may be a general-purpose computer system that is programmable using a high-level computer programming language. Computer system 400 may be also implemented using specially programmed, special purpose hardware. In computer system 400, processor 403 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures, Eighth Edition.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. An interface of a game, the interface being stored in a memory of a computer system having a display and being presented by the computer system to a player of the game, the interface comprising:
a first meter; and
a second meter, wherein the first and second meters are displayed to the player in the display of the computer system, wherein the second meter is adaptively coupled to the first meter.

2. The interface of the game according to claim 1, wherein the game is an electronic game.

3. The interface of the game according to claim 2, wherein the game is a game of skill.

4. The interface of the game according to claim 2, wherein the game is a game of chance.

5. The interface of the game according to claim 2, wherein the game player plays the game through the interface.

6. The interface of the game according to claim 5, wherein the player is permitted to subscribe to play one or multiple game sessions though the interface.

7. The interface of the game according to claim 6, wherein the player is permitted to automatically renew the subscription through the interface.

8. The interface of the game according to claim 2, wherein the player is permitted to enter a game session through an alternative method of entry (AMOE).

9. The interface of the game according to claim 2, wherein the game involves a plurality of players, each of which play against each other.

10. The interface of the game according to claim 2, wherein a player is presented the interface through at least one of a television, a personal computer, a handheld device, a telephone having a display, and a kiosk.

11. The interface of the game according to claim 1, wherein the first meter indicates a play level and the second meter indicates a game level.

12. The interface of the game according to claim 11, wherein at least one of the first and second meters are initialized to an initial value.

13. The interface of the game according to claim 12, wherein the initial value is greater than a minimum value permitted by the at least one of the first and second game meters.

14. The interface of the game according to claim 12, wherein the initial value is a middle value proximate the center of an allowed range of indications shown by the at least one of the first and second game meters.

15. The interface of the game according to claim 11, wherein good play by the player increases a displayed value of the first meter and poor play by the player decreases the displayed value of the first meter.

16. The interface of the game according to claim 15, wherein a displayed value of the second meter increases when the first meter attains a maximum level and the displayed value of the second meter decreases when the first meter attains a minimum level.

17. The interface of the game according to claim 15, wherein the displayed value of the first meter is reset to an initial value when at least one of a minimum level and a maximum level indicated by the first meter is reached.

18. The interface of the game according to claim 15, wherein game play for the player is ended when the displayed value of the second meter reaches a minimum level.

19. The interface of the game according to claim 11, wherein the difficulty of the game adjusts as levels displayed by the first and second meters change.

20. The interface of the game according to claim 11, further comprising a third meter that indicates a prize level.

21. The interface of the game according to claim 20, wherein the third meter is initialized to a level that corresponds to the player not winning a prize.

22. The interface of the game according to claim 20, wherein a displayed value of the third meter is increased when a displayed value of the second meter reaches a maximum level and is decreased when the displayed value of the second meter reaches a minimum level.

23. The interface of the game according to claim 2, wherein the game is a timed game, and wherein the player plays the game within a time limit.

24. The interface of the game according to claim 9, wherein the game is a timed game, and wherein each of the plurality of players plays the game within a time limit.

25. The interface of the game according to claim 9, further comprising a third meter that indicates a prize level, and wherein the game play of the plurality of players is ended when at least one of the plurality of players attains a maximum prize level indicated by the third meter.

26. The interface of the game according to claim 24, wherein each of the plurality of players plays the game using an interface having a respective third meter that indicates a prize level associated with each respective player, and wherein each of the plurality of players win prizes indicated by their respective third meter when the time limit is reached.

27. The interface of the game according to claim 24, wherein no players win if the time limit is reached before the maximum prize level is attained by any one of the plurality of players.

28. The interface of the game according to claim 6, wherein the payout to a player for winning is increased with an increased payment received by the player to play.

29. The interface of the game according to claim 2, wherein the game includes at least one progressive jackpot.

30. The interface of the game according to claim 2, wherein the game includes a plurality of game sessions that are run periodically.

31. The interface of the game according to claim 2, further comprising means for displaying, to a plurality of players playing the game, an indication of a winning player.

32. The interface of the game according to claim 2, further comprising means for displaying, to a plurality of players playing the game, an indication of at least one of a winning game and a winning player.

33. The interface of the game according to claim 2, wherein the computer system determines at least one of a game card or a player closest to winning, and the interface further comprises means for displaying to at least one of a plurality of players playing the game an indication of the at least one of the game card or the player closest to winning.

34. The interface of the game according to claim 2, wherein game sessions are run continuously, and wherein at least one advertising stream is inserted into the interface during a game session.

35. The interface of the game according to claim 2, wherein game sessions are run continuously, and wherein at least one advertising stream is displayed in the interface between individual game sessions.
